(19) United States
(12) Patent Application Publication
(10) Pub. No.: US 2007/0194054 A1
(43) Pub. Date: Aug. 23, 2007

(54) Fluid product dispenser

(76) Inventors: Wilhelmus E. Ganzeboom, Haarlem (NL); Fedor C. Kadiks, Hillegom (NL)

Correspondence Address: TRASK BRITT, P.O. BOX 2550, SALT LAKE CITY, UT, 84110, US

(21) Appl. No.: 11/657,195

(22) Filed: Jan. 24, 2007

Related U.S. Application Data
(60) Provisional application No. 60/762,523, filed on Jan. 27, 2006.

(30) Foreign Application Priority Data
Jan. 25, 2006 (EP) 06075177.3

(51) Int. Cl. B67D 5/58

(52) U.S. Cl. 222/190

(57) ABSTRACT

A dispenser for dispensing a fluid product includes a liquid reservoir for storing a liquid product and a pump that is connected to the liquid reservoir. The pump may include a liquid chamber for containing a dose of the liquid product, a liquid outlet valve for regulating passage of liquid product from the liquid chamber to a dispensing head, compression means for applying a compressional force to liquid product in the liquid chamber, thus forcing liquid product from the liquid chamber through the liquid outlet valve and through the dispensing head. The dispenser may also include a liquid inlet device for administering admission of liquid product into the liquid chamber from the liquid reservoir. The liquid inlet device may include a body of solid material in which at least one constrictive passage is provided. The constrictive passage may be constantly open and serve to allow passage of liquid product back and forth between the liquid reservoir and the liquid chamber.

### CROSS-REFERENCE TO RELATED APPLICATIONS

This application claims priority pursuant to the Paris Convention to European Patent Application 06075177.3, filed Jan. 25, 2006, the disclosure of which is hereby incorporated herein, in its entirety, by this reference. This application also claims the benefit of U.S. Provisional Application No. 60/762,523, filed Jan. 27, 2006, the disclosure of which is hereby incorporated herein, in its entirety, by this reference.

### BACKGROUND OF THE INVENTION

1. Field of the Invention

The present invention relates to dispensers for dispensing fluid products. More specifically, the present invention relates to a dispenser that includes a liquid reservoir for storing a liquid product and a pump that is connected to the liquid reservoir and that includes, among other things, a liquid inlet valve with a constricted, or relatively small, passageway.

2. Background of Related Art

Dispensers are well known, and are described, inter alia, in U.S. Pat. No. 5,732,853, the disclosure of which is hereby incorporated herein, in its entirety, by this reference. Such dispensers are, for example, employed in washrooms, toilets, kitchens, hospitals, surgeries, hair/beauty salons, workshops and factories. In many cases, such dispensers are fitted in a holder that is mounted to a wall, often in the vicinity of a basin, bath, shower or toilet bowl; alternatively, such dispensers may be free-standing, and may be placed on a shelf, worktop or wash hand basin, or a trolley. In use, the pump is typically operated by hand, arm or elbow so as to dispense a quantity of fluid product. In general, this fluid product will be dispensed into the operator's hand, or onto a carrier such as a tissue or cloth, after which the fluid product is rubbed onto the skin or hair, or is applied from the carrier onto a surface to be sanitized, such as a toilet seat.

In known dispensers of the type described above, the liquid inlet device is embodied as a non-return valve, which is located in the pump. Such a valve may, for example, take the form of a ball bearing that is forced by a spiral spring against a valve seat, so as to be biased shut (see item 10 in FIG. 1 of U.S. Pat. No. 5,732,853, for example). During the compression stroke of the compression means (see piston 7 in FIG. 1 of U.S. Pat. No. 5,732,853, for example), this valve will remain shut. However, during the relaxation stroke of the compression means, a negative pressure will arise in the liquid chamber (see bore 8 in FIG. 1 of U.S. Pat. No. 5,732,853, for example). If the inward force exerted on the ball bearing as a result of this negative pressure exceeds the elastic biasing force F₀ of the spiral spring, then the ball bearing will move away from the valve seat, and liquid product will be sucked through the valve from a connected liquid reservoir (see bag 15 in FIG. 1 of U.S. Pat. No. 5,732,853); however, once the relaxation stroke has ended and the negative pressure in the liquid chamber disappears again, the valve will shut once more.

Another example of non-return liquid inlet valve construction includes a ball bearing/valve seat employed without a biasing spring. In such a scenario, the existence of positive pressure in the liquid chamber during the compression stroke will force the ball bearing against the valve seat, thus shutting the valve; on the other hand, once the compression stroke has ended and the positive pressure in the liquid chamber disappears again, the ball bearing will no longer be forced against the valve seat, and the valve may open. This type of liquid inlet valve is disclosed in U.S. Pat. No. 5,271,530, for example (see items 3j and 8 in FIG. 2 of U.S. Pat. No. 5,271,530). Instead of a ball bearing, a valve in the form of a barbed, shuttle-like member may be used, as disclosed in U.S. Pat. No. 5,445,288, for example. Such a valve shuts in response to a build-up of pressure in the liquid chamber. Self-biasing valves, such as the so-called “duckbill” valve described in co-pending U.S. Provisional Patent Application Ser. No. 60/683,321, filed May 23, 2005, have also been used in dispensers. Such a valve takes the form of a tapered, resilient sleeve, which is default shut. When a sufficient pressure differential is created through the sleeve (in the correct direction), the sleeve walls in the tapered portion will part, thus allowing flow through the sleeve; on the other hand, when the pressure differential falls again below a certain threshold, the sleeve walls will close in upon themselves once more, thus inhibiting flow through the sleeve. As an alternative to a duckbill valve, so-called “umbrella” valves have also been employed.

Non-return liquid inlet valves have certain attendant disadvantages. Since they generally comprise precision moving parts, they may be relatively difficult and expensive to manufacture. Moreover, machining or performance specifications for these parts often require them to be made from specific materials, which may not be optimally compatible with the liquid product being used (e.g., a metal ball bearing may corrode as a result of contact with certain components of liquid soap).

### SUMMARY OF THE INVENTION

For purposes of clarity and consistency, the following terms as used throughout this text and the appended claims should be interpreted as follows:

The term “fluid” encompasses a liquid, a suspension of a granulated solid in a liquid, a gel, a foam, and a spray, for example.

The term “product” encompasses soap (including shower gel), shampoo, disinfectant (including alcohols), detergent, moisturizer, and hair conditioner, for example, including mixtures of these substances.

The terms “compression means” and “pressurizing means” encompass a piston, bellows, balloon, and/or membrane, for example.

The “liquid product” may be dispensed directly through the pump, or may first be mixed with another substance, such as air or another gas, another liquid, or a granulated solid, for example.

The term “reservoir” refers to any suitable type of container, whether rigid or flexible, such as a bottle, flask, or bag, for example.

The present invention includes a dispenser for dispensing a fluid product. Such a dispenser includes a liquid reservoir for storing a liquid product and a pump that is connected to the liquid reservoir. The pump may include a liquid chamber for containing a dose of liquid product, a liquid outlet valve for regulating passage of liquid product from the liquid chamber to a dispensing head, and compression means for applying a compressional force to liquid product in the liquid chamber, thus forcing liquid product from the liquid chamber through the liquid outlet valve and through the dispensing head. The dispenser may also include a liquid inlet device for administering admission of liquid product into the liquid chamber from the liquid reservoir.

In some embodiments, the pump may be located above the liquid reservoir, with the liquid outlet valve above the liquid inlet device (hereinafter referred to as a “standing configuration”). In other embodiments, the pump may be located below the liquid reservoir, with the liquid outlet valve below the liquid inlet device (hereinafter referred to as a “hanging configuration”). Other configurations are, of course, also possible; e.g., with the pump located at a side of the liquid reservoir (with the liquid outlet valve at the side of the liquid chamber remote from the liquid reservoir, and the liquid inlet device at the opposite side of the liquid chamber).

A liquid inlet device that incorporates teachings of the present invention may be relatively easy to manufacture (e.g., have relatively high manufacturing tolerances, etc.) and be more compatible than existing liquid inlet devices with the liquid product to be dispensed. A liquid inlet device according to the present invention may include a body of solid material in which at least one constrictive passage is provided, the constrictive passage being constantly open and serving to allow passage of liquid product back and forth between the liquid reservoir and the liquid chamber.

In a dispenser according to the present invention, the body of solid material of the liquid inlet device may be comprised of a wide variety of substances, which may be chosen to be adequately compatible with the properties of the liquid product being used. A liquid inlet device according to the invention does not have to have moving parts, and may thus be manufactured relatively simply and inexpensively. The desired constrictive passage(s) in a liquid inlet device may be created using a variety of relatively straightforward techniques, or may even be intrinsically present in the employed body of solid material by virtue of its physical constitution. These points will become more apparent from the discussion below.

The inventors believe that the operation of the liquid inlet device in the dispenser according to the invention depends on inertial effects, which are of different significance during the pump's compression stroke (when the compression means are enacted so as to apply a compressional force (positive pressure) to liquid product in the liquid chamber) and the pump's relaxation stroke (when the compression means are relaxed (e.g., as a piston withdraws outward, or as a bellows or balloon expands) after a previous compression stroke, thus creating a negative pressure in the liquid chamber). This may be further elucidated as follows:

During the relaxation stroke of the pump, liquid product is sucked into the liquid chamber from the liquid reservoir through the constrictive passage(s) of the liquid inlet device. The constrictive nature of the passage(s) offers resistance to the flow of liquid product, as a result of which the flow of liquid product into the liquid chamber will be relatively slow. However, the time required for liquid product to be sucked into the liquid chamber in this manner is relatively short compared to the typical interval between compression strokes of the pump in common applications. Therefore, despite the flow impedance offered by the constrictive passage(s), there will typically be sufficient time for the liquid chamber to satisfactorily fill before the next compression stroke.

On the other hand, during the compression stroke of the pump, a compressional force will generally be applied to the liquid chamber in quite a rapid manner (often lasting only a fraction of a second in typical applications). Although the application of such a compressional force will tend to cause some liquid product to migrate back out of the liquid chamber and into the liquid reservoir via the constrictive passage(s) of the liquid inlet device (which is always open), a much greater body of liquid product will leave the liquid chamber via the much easier path of the opened liquid outlet valve, which offers a much broader escape route than the constrictive passage(s) of the liquid inlet device.

The inventors have been able to tailor the size, shape or configuration, and number of constrictive passages in the liquid inlet device so as to achieve various degrees of this “back migration” of liquid product out of the liquid chamber and through the liquid inlet device during the compression stroke. In many examples, a back migration of the order of 15% was realized, which was found to give very satisfactory dispenser performance results. For example, in the case of a foam pump that mixes air with liquid to produce foam (such as foam soap; see, e.g., U.S. Pat. Nos. 5,271,530 and 5,445,288, the disclosure of which is hereby incorporated herein, in its entirety, by this reference), the quality and quantity of dispensed foam in the case of a dispenser according to the invention with about 15% back migration were found to be very satisfactory as compared to an identical dispenser in which a traditional non-return liquid inlet valve had been substituted for the liquid inlet device of the current invention.

If desired, the effects of such back migration on the (quantity and/or quality of the) dispensed fluid product may be mitigated by, for example: appropriately enlarging the volume of the liquid chamber; and, in the case of a foam pump, appropriately reducing the volume of the attendant air chamber.

In an aspect of the invention, the degree of back migration may be reduced by lending a particular form to the constrictive passage(s) in the liquid inlet device of the inventive dispenser. More specifically, in a particular embodiment of the invention, if z denotes the direction of liquid flow from the liquid reservoir through the liquid inlet device and into the liquid chamber, then the cross-sectional area of the/each constrictive passage changes as a function of z, at least over a portion of its length. For example, the constrictive passage(s) may assume a (quasi) Venturi geometry that tapers along the z direction. Such particular forms of constrictive passage may be successfully manufactured using an injection molding procedure, for example. The rationale behind this approach is that, in the case of such a tapered constrictive passage, a discrepancy in flow resistance is observed depending on the direction of flow through the passage. The sign/sense of this discrepancy depends on properties such as the viscosity of the liquid product. Therefore, depending on the particulars of a given situation, one may decide to have the constrictive passage(s) taper inward in the +z or the −z direction, to reduce or minimize back-migration in the −z direction.

A dispenser according to the present invention may be used in a hanging configuration. Existing dispensers with non-return inlet valves that are in default open positions could not be hung, as liquid product would leak out of a reservoir of a dispenser with which such a default-open non-return inlet valve is used, and through the pump with which the valve is associated, to the outside world. Existing dispensers with liquid inlet valves that are normally biased shut may also leak when hung, particularly when the valves of such dispensers become jammed in an open position. In the case of a dispenser that incorporates teachings of the present invention, such leakage will generally be less significant, since the leakage rate of liquid product through the constrictive passage(s) of an inventive liquid inlet device will typically be substantially less than the leakage rate of liquid product through an open non-return inlet valve of an existing dispenser.

In a dispenser according to the invention, a liquid inlet device can, in principle, be located at any point in the liquid path from the liquid reservoir to the liquid chamber. For example, the liquid inlet device may be situated in any of the following locations: in the pump, at or proximal to an entrance orifice to the liquid inlet chamber; in the liquid reservoir, at or proximal to an exit orifice of the liquid reservoir to which the pump is connected; in a docking device between the pump and the liquid reservoir, such as in a collar or neck that acts as an interface between the pump and the liquid reservoir; or in a liquid inlet duct that emerges into the liquid chamber of the pump. A liquid inlet duct may, for example, comprise: (part of) a dip tube; a docking tube, serving to connect the pump to a docking device on the liquid reservoir; or a puncture tube, serving to puncture through a sealing element at an exit orifice of the liquid reservoir, thus opening a liquid flow path when the pump and liquid reservoir are docked. A liquid inlet device according to the present invention may extend, or span, across the full cross-section of the liquid flow path in which it is located, at the point at which it is located or extend, or span, across such a large portion of the cross-section that any flow gap past the liquid inlet device and external thereto is so small as to itself constitute a constrictive passage.

In a particular embodiment of a dispenser according to the invention, the liquid inlet device comprises a sheet of substantially impermeable foil in which one or more through-holes have been provided (i.e., the body of solid material referred to earlier is a sheet of foil, and the/each constrictive passage is a through-hole). The material of the foil can, in principle, be any material that is compatible with the liquid product, such as a plastic foil or metal foil, for example. The through-hole(s) may simply be pricked through the foil with a pin, or more sophisticated techniques may be used to form the through-hole(s), such as laser perforating, for example. Moreover, the through-hole(s) may be created in the foil either before or after it is positioned in its final location.

In a refinement of this basic approach, a large number of relatively small through-holes may produce more satisfactory results than a smaller number of relatively large through-holes, although any number of holes and holes of any size may be used without departing from the scope of the present invention.

In another embodiment of a dispenser according to the invention, the liquid inlet device comprises a body of fibrous material (e.g., the body of solid material referred to earlier is a mass of fibers, and each constrictive passage is a pathway between the fibers). Assuming that it is compatible with the liquid product in question, such fibrous material may comprise synthetic substances, such as synthetic felt, fiberglass, metal wool, or the like. Alternatively, a natural fibrous material, such as linen, muslin or silk, for example, or a natural felt material (e.g., coconut fiber, animal hair, etc.), may be used.

In yet another embodiment of a dispenser according to the invention, the liquid inlet device comprises a body of granulate material (i.e., the body of solid material referred to earlier is a mass of grains, and each constrictive passage is a pathway between the grains). Examples of such grains include sand and quartz, which may, for example, be compacted into an aggregate body kept in shape by a retaining “cage”.

In a further embodiment of a dispenser according to the invention, the liquid inlet device comprises an elongate plug of solid material having an outer surface in which a plurality of longitudinal furrows has been provided. This plug is preferably cylindrical in form. As an alternative to such furrows, or in addition thereto, longitudinal bores may be provided through the bulk of the plug. Note in the current context that the syntax “elongate plug” should be broadly construed as encompassing a (quasi) cylinder with a diameter that is greater than or equal to its length along its cylindrical axis, as well as a cylinder with a diameter that is smaller than its length along its cylindrical axis.

A pump that may be employed in a dispenser according to the invention may be any type of pump suitable under the circumstances. In one type of pump, for example, liquid product is dispensed directly by the pump to the outside world; the fluid product in this case is thus the liquid product. Such pumps are well known in the art and are, for example, widely employed in liquid soap dispensers for domestic use.

In another type of pump suitable for use in a dispenser according to the invention, the fluid product is foam. Such a pump may additionally include: an air chamber for containing air; an air inlet valve for admitting air into the air chamber; an air outlet device for conducting air from the air chamber to the dispensing head; pressurizing means for reducing the volume of the air chamber, thus forcing air from the air chamber through the air outlet device; and a mixing element, located in the dispensing head, for mixing liquid product and air emanating from the respective liquid and air chambers; or any combination of the foregoing.

The mixing element may, for example, be a mixing chamber and/or a porous member, such as a gauze, sieve or mesh, for example. The air outlet device may be a valve, a narrow duct, a swan neck, or a labyrinth passage, for example. The term “air” should be broadly interpreted as encompassing other gases, such as N₂, for example. A foam pump of this type is described, for example, in U.S. Pat. No. 5,271,530 and U.S. Patent Application Publication 2004/0149777 of Taplast, the disclosure of which is hereby incorporated herein, in its entirety, by this reference.

In yet another type of pump that may be used in a dispenser according to the invention, the fluid product is a spray. Such a pump, which is configured to nebulize liquid in a manner known in the art, includes a liquid outlet valve with a constriction, in accordance with teachings of the present invention.

A dispenser according to the invention may be used in a holder that includes a housing for removably accommodating at least part of the dispenser. The holder may also include one or more of: an actuating organ movably connected to the housing and serving to cooperate with the pump, whereby the pump may be actuated by manually moving the actuating organ; a detector for detecting that a member onto which fluid is to be dispensed has been offered to the dispensing head of the pump; and an electric actuator, for actuating the pump on the basis of a signal output from the detector.

The actuating organ may comprise a lever, button, hinged part, or wheel, for example. The actuating organ may be an integral part of the pump, such as in the case of a cap on a moving part of the pump. The detector may be configured to detect heat, movement, the interruption of a light beam, a change in scattered light intensity (albedo change), or the like, so as to detect when a member, such as a hand, cloth or tissue, is being offered to the dispensing head; i.e., to detect when the member is appropriately positioned to receive fluid product dispensed from the dispensing head. A holder may also include means for mounting (e.g., screw holes, magnets, adhesive elements, etc.) the housing to a surface, such as a wall.

Other features and advantages of the present invention will become apparent to those of skill in the art through consideration of the ensuing description, the accompanying drawings, and the appended claims.

### BRIEF DESCRIPTION OF THE SEVERAL VIEWS OF THE DRAWINGS

The invention will now be elucidated in more detail on the basis of the embodiments described hereinafter in reference to the accompanying schematic drawings, in which:

FIG. 1 depicts a longitudinal cross-section of part of a dispenser for dispensing a fluid product;

FIG. 1a shows a modification of the subject of FIG. 1;

FIG. 2 depicts a longitudinal cross-section of part of a dispenser for dispensing a fluid product according to an embodiment of the current invention. In particular, FIG. 2 depicts a pump;

FIG. 2a shows a detailed exploded view of part of the subject of FIG. 2;

FIG. 3 shows a detailed exploded view of part of a dispenser for dispensing a fluid product according to another embodiment of the current invention. In particular, FIG. 3 shows an alternative to the scenario in FIG. 2a;

FIG. 4 renders a perspective view of a holder for accommodating a dispenser according to the invention; and

FIG. 5 renders a longitudinal cross-sectional view of the subject of FIG. 4, taken along the line A-A′.

In the figures, corresponding features are indicated by corresponding reference symbols.

### DETAILED DESCRIPTION OF THE INVENTION

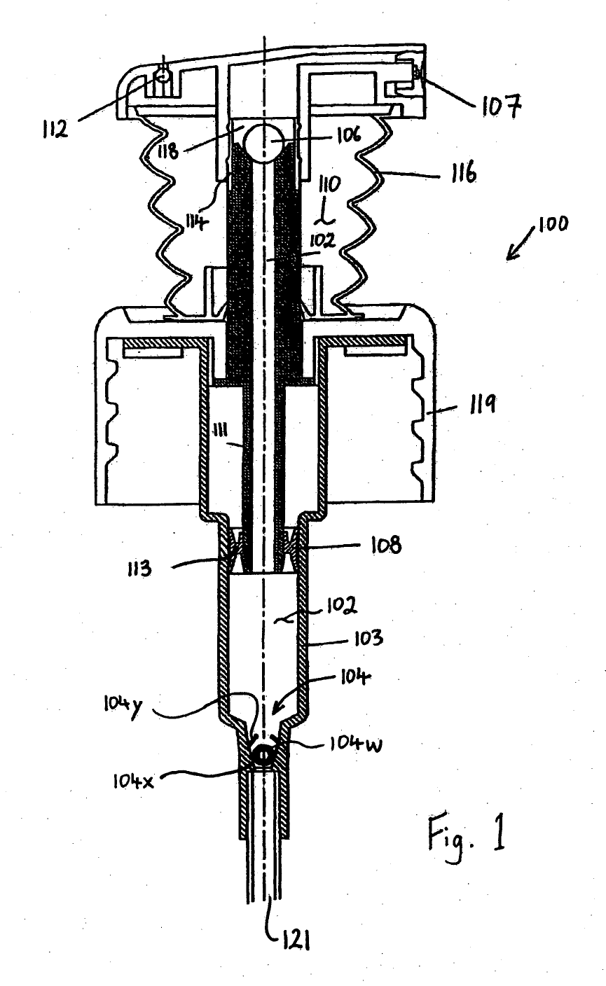

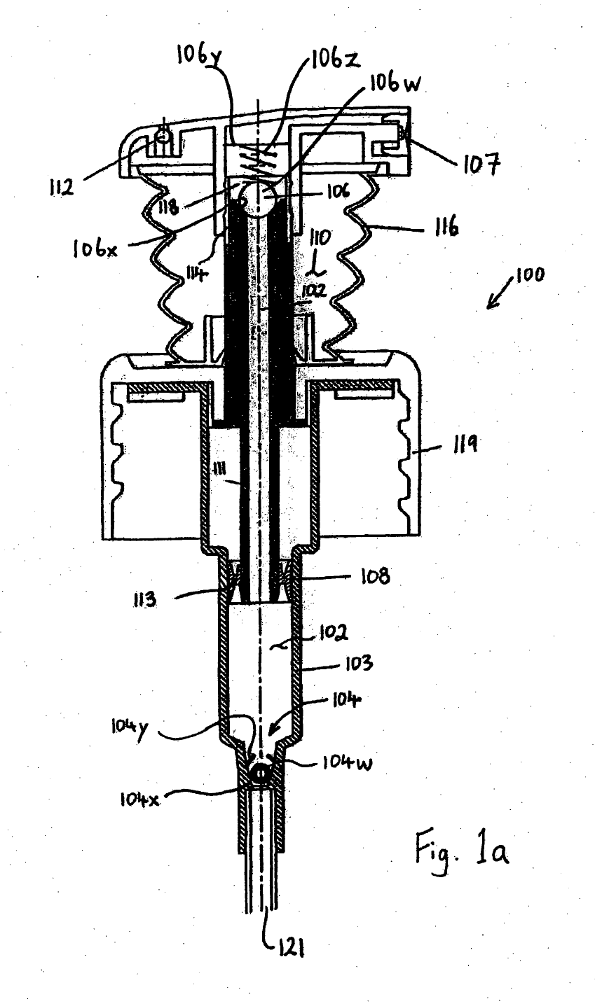

FIG. 1 renders a longitudinal cross-sectional view of part of a dispenser for dispensing a fluid product. More specifically, FIG. 1 depicts a pump 100 that may be employed in such a dispenser. In use, the pump 100 may be connected to a liquid reservoir for storing a liquid product; such a liquid reservoir is not depicted in FIG. 1, but will be discussed later. In this particular case, the fluid product concerned is a foam, produced by mixing a liquid product with air.

The pump 100 includes a liquid chamber 102 for containing a dose of the liquid product, a liquid outlet valve 106 for regulating passage of liquid product from the liquid chamber 102 to a dispensing head 107, and compression means 108 for applying a compressional force to liquid product in the liquid chamber 102, thus forcing liquid product from the liquid chamber 102 through the liquid outlet valve 106 and through the dispensing head 107. The pump 100 may also include an air chamber 110 for containing air, an air inlet valve 112 for admitting air into the air chamber 110, an air outlet device 114 for conducting air from the air chamber 110 to the dispensing head 107, pressurizing means 116 for reducing the volume of the air chamber 110, thus forcing air from the air chamber 110 through the air outlet device 114, and a mixing element 118, located in the dispensing head 107, for mixing liquid product and air emanating from the respective liquid chamber 102 and air chamber 110.

Also shown in FIG. 1 is a liquid inlet device 104 for administering admission of liquid product into the liquid chamber 102 from the (non-depicted) liquid reservoir referred to above. In this pump 100, the liquid inlet device 104 may be a non-return valve situated at the entrance to the liquid chamber 102. The liquid inlet device 104 is located upstream of a liquid inlet duct 121, which connects the liquid chamber 102 to the liquid reservoir.

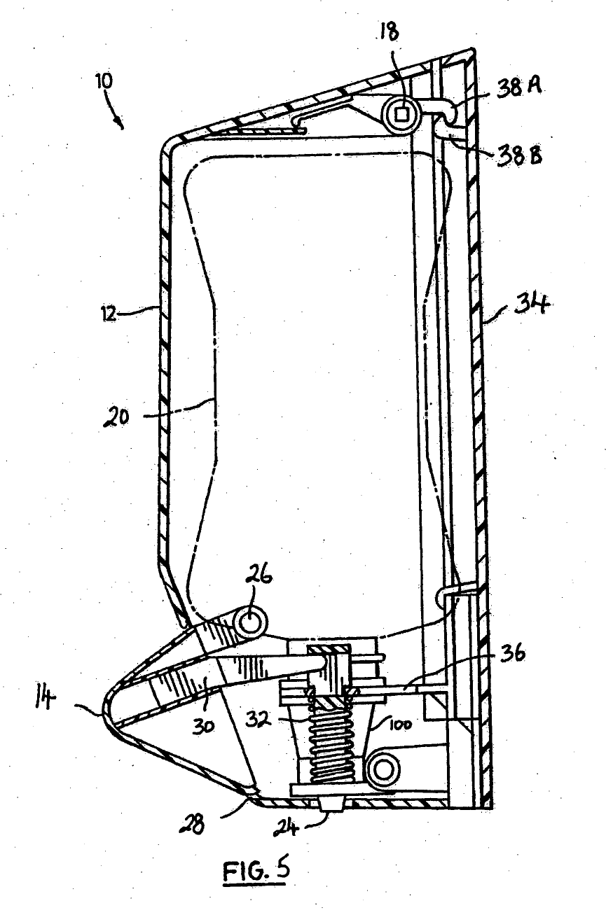

The pump 100 may be attached to the liquid reservoir with the aid of the collar 119, for example. FIG. 5 shows a pump 100 coupled to a liquid reservoir 20 in a hanging configuration, for example. As an alternative to the hanging configuration in FIG. 5, the pump 100 may also be used in a standing configuration, whereby it is mounted (e.g., with the aid of the collar 119) on top of a liquid reservoir (such as a bottle); in this latter case, the liquid inlet duct 121 may be connected to the bottom of the liquid reservoir in the form of a dip tube, for example. Such a standing configuration of pump and liquid reservoir is well known in the art.

In the illustrated embodiment, the following design choices have been made:

(I) The compression means 108 may be a piston, with a piston shaft 111 and an attached piston head 113, which may be moved telescopically in and out of a piston tube 103. The piston shaft 111 is hollow, and has a central passage that forms part of the liquid chamber 102. Moving the dispensing head 107 toward the collar 119 causes the piston 108 to start a compression stroke, applying positive pressure to a dose of liquid product present in the liquid chamber 102. On the other hand, moving the dispensing head 107 away from the collar 119 causes the piston 108 to start a relaxation stroke, inducing a build-up of negative pressure in the (empty) liquid chamber 102. If desired, elastic biasing means (such as a spring) may be employed to ensure that the piston 108 starts its relaxation stroke of its own accord once it is released from its compression stroke.

(II) The liquid inlet valve 104 may be a ball bearing 104w that is free to move between a valve seat 104x and a retaining flange 104y. On the one hand, the ball 104w may be pressed in a sealing manner against the valve seat 104x, thus preventing liquid flow past the valve 104; on the other hand, the flange 104y will act as a retainer, serving to prevent the ball 104w from displacing into the liquid chamber 102, but being shaped in such a manner as to allow liquid flow past the valve 104. During the compression stroke referred to above, the build-up of positive pressure within the liquid chamber 102 will push the ball 104w against the valve seat 104x, thus closing the liquid inlet valve 104. However, during the ensuing relaxation stroke, the occurrence of negative pressure within the liquid chamber 102 will pull the ball 104w away from the valve seat 104xand toward the retaining flange 104y, thus opening the liquid inlet valve 104.

(III) The liquid outlet valve 106 may be a ball bearing 106w that cooperates with a valve seat 106x and a retaining flange 106y. During the compression stroke referred to above, either the build-up of positive pressure within the liquid chamber 102 or a mechanical connection between the dispensing head 107 and the liquid outlet valve 106 will cause the ball 106w to move away from the valve seat 106x, thus opening the liquid outlet valve 106. In reverse fashion, during the ensuing relaxation stroke, the ball 106w will move toward the valve seat 106x, thus closing the liquid inlet valve 106. If desired, the liquid outlet valve 106 may be biased shut, e.g., using biasing means, such as a spiral spring 106z, as depicted in FIG. 1a.

(IV) The pressurizing means 116 may be a bellows, within which the air chamber 110 is located. Moving the dispensing head 107 toward the collar 119 compresses the bellows 116, reducing the volume of the air chamber 110 and thus forcing air from the air chamber 110 through the air outlet device 114, which, in the depicted embodiment, includes a labyrinth of narrow passages. Moving the dispensing head 107 away from the collar 119 causes the bellows 110 to relax, whereby air will be drawn into the bellows 110 through the air inlet valve 112, which is shown as including a ball bearing that cooperates with a valve seat. If the bellows 110 is made of resilient material, such as flexible plastic or rubber, it will be self-relaxing.

The skilled artisan will appreciate that these are free design choices, and that many other worthy alternatives are available, as alluded to earlier in this text. In particular, the pump structure illustrated in FIGS. 1 and 1a lends itself to use in a standing or hanging configuration.

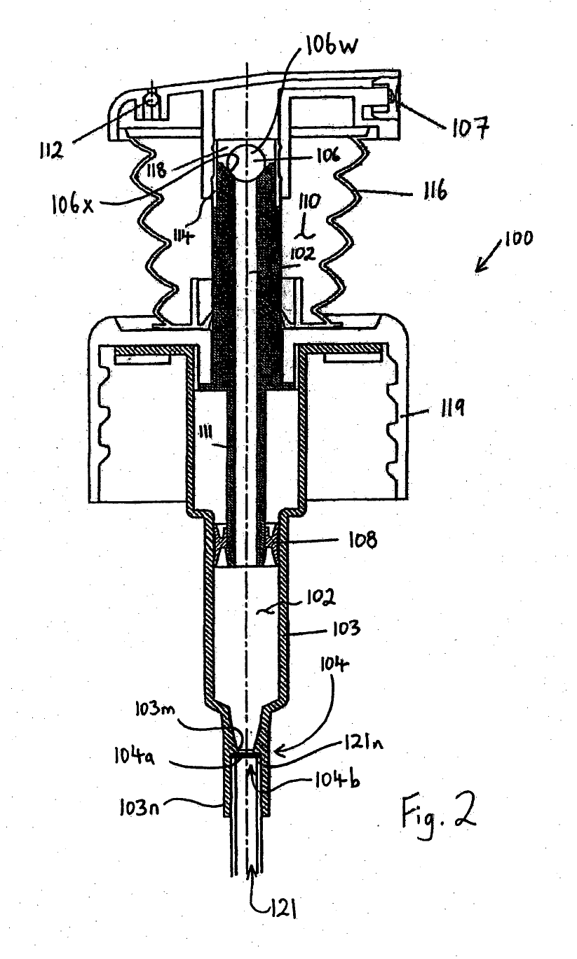

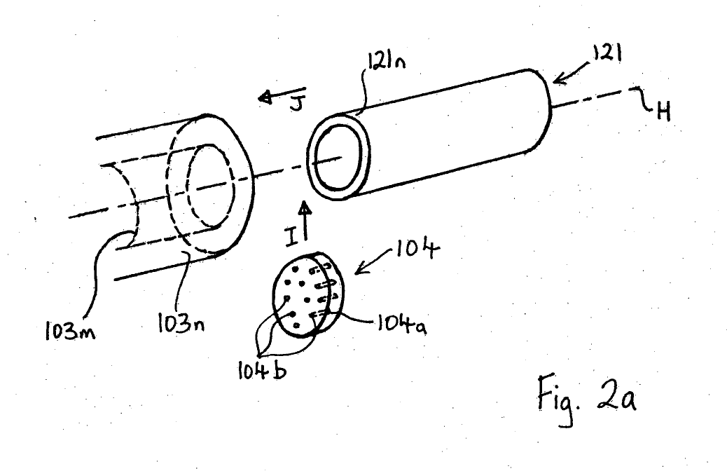

FIG. 2 depicts a longitudinal cross-section of part of a dispenser for dispensing a fluid product according to an embodiment of the current invention In particular, FIG. 2 depicts a pump 100 suitable for use in such a dispenser. The pump 100 in FIG. 2 is identical to that in FIG. 1 (or FIG. 1a), except as regards the structure and operation of the liquid inlet device 104. Part of the pump 100 in FIG. 2 is shown in a more detailed exploded view in FIG. 2a.

According to the invention, an embodiment of the liquid inlet device 104 includes a foil 104a that extends, or spans, across the full internal diameter of the liquid inlet duct 121. The foil 104a is a body of solid material that is impermeable to the liquid product to be employed with the pump 100. However, several constrictive passages 104b, such as narrow through-holes, have been created through the plane of the foil 104a. These passages 104b are always open, and serve to allow passage of liquid product back and forth between a liquid reservoir (not depicted, but located below the liquid inlet duct 121 of the pump 100 shown in FIG. 2) and the liquid chamber 102. The (cumulative) cross-sectional area of the constrictive passage(s) 104b (viewed parallel to the plane of foil 104a) is substantially smaller than the cross-sectional area of the liquid escape route that arises in the liquid outlet valve 106 during the compression stroke (in the case of FIG. 2, this is when the ball 106 moves away from the valve seat 106x to its greatest extent).

One way to realize such an arrangement is illustrated in FIG. 2a. In that figure, the foil 104a has been formed so that its cross-section is substantially the same shape and size as that of the liquid inlet duct 121. The foil 104a is moved into place (arrow 1) over the butt end 121n of the liquid inlet duct 121, where it may be held in place with the aid of an adhesive or via heat sealing, for example. The butt end 121n of the liquid inlet duct 121, with the foil 104a in place, is then slid into the receiving butt end 103n of the piston tube 103 (arrow J). As an alternative to the use of an adhesive or heat seal, the foil 104a may simply be clamped in place between the butt end 121 of the liquid inlet duct 121 and a flange 103m within the piston tube 103. As depicted in FIG. 2a, the constrictive passages (through-holes) 104b have been provided in the foil 104a prior to its placement in the pump 100; however, as an alternative, it is also possible to place the foil 104a in the pump 100 before creating the constrictive passages 104b.

It should be noted that the liquid inlet device 104 does not have to be situated at the location shown in FIGS. 2 and 2a; instead, if desired, it may be located at another position, such as another point in the liquid inlet duct 121 or in the butt end 103n of the piston tube 3. Indeed, there is no requirement that the liquid inlet device 104 be located in the pump 100; instead, it may be located at, or proximal to, an exit orifice of the liquid reservoir to which the pump 100 is to be connected, for example.

In one set of tests, the employed pump 100 was an Airspray M3 foam pump (see www.airspray.nl) in which the non-return liquid inlet valve had been removed. The foil 104a had a polyethylene/polyamide multilayer structure with a cumulative thickness of approximately 95 μm. Through-holes 104b were created in a circular area of the foil 104a that had a diameter of approximately 4 mm, corresponding to the internal diameter of the liquid inlet duct 121. The holes 104b themselves had a diameter in the range 0.1-0.25 mm (depending on the test sample in question), and the number of holes 104b per foil 104a varied between one and thirty (again depending on the test sample in question). In the case of test samples with thirty holes, a back migration of about 17% was observed, regardless of whether the rest time between successive compression strokes was, for example, 2 seconds, 1 second or 0.5 seconds, and also regardless of the chosen value of the hole diameter within the range 0.1-0.25 mm.

In another embodiment, the foil 104a (see FIGS. 2 and 2a) is replaced by a body (e.g., a pad or plug) of synthetic felt 104. This felt body 104 does not need to be provided with special through-holes 104b, since the many tortuous passages intrinsically present between the fibers of the felt act as the constrictive passages required by the invention.

In one set of tests, performed using a modified Airspray M3 foam pump, the felt body 104 comprised polyester fibers, and was cylindrical in shape, with a diameter of just over 4 mm and a length of 8 mm. This felt body 104 was inserted into the inside of the liquid inlet duct 121, which had an internal diameter of 4 mm. Use of a felt body 104 in this manner also yielded a back migration of about 17%, regardless of whether the rest time between successive compression strokes was 2 seconds, 1 second or 0.5 seconds.

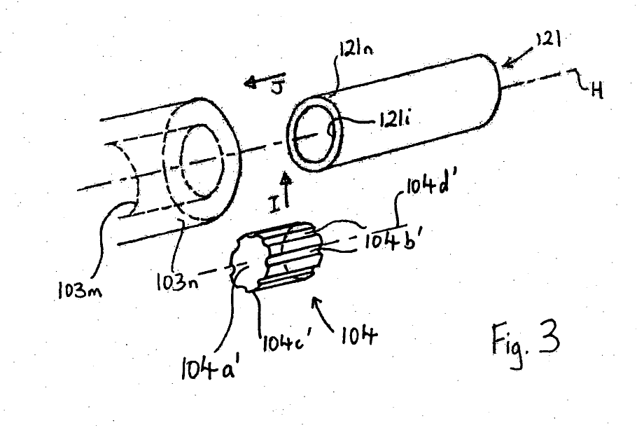

FIG. 3 shows a detailed exploded view of part of yet another embodiment of a dispenser for dispensing a fluid product according to another embodiment of the current invention. In FIG. 3, the liquid inlet device 104 comprises an elongate plug 104a′ of solid material having an outer surface 104c′ in which a plurality of longitudinal furrows 104b′ has been provided. The plug 104a′ may be cylindrical in shape, and the furrows 104b′ extend parallel to its cylindrical axis 104d′; however, the plug 104a′ may also have tapered butt ends, for example, whereas the furrows 104b′ may also spiral about the axis 104d′, or be sheared diagonally with respect to the axis 104a′. The plug 104a′ is so dimensioned as to fit snugly and tightly within the liquid inlet duct 121, whereby (at least part of) the outer surface 104c′ of the plug is juxtaposed against the inner surface 121i of the liquid inlet duct. Such a plug 104a′ with surfacial furrows 104b′ can, for example, be conveniently and cheaply manufactured (e.g., in a single step, etc.) using an injection molding procedure.

In a particular embodiment, the plug 104a′ has a length of approximately 7 mm along its cylindrical axis, and a diameter of 4 mm. Ten longitudinal furrows are provided on its surface, each furrow having a substantially semi-circular cross-section with a diameter of 0.4 mm. The plug 104a′ and furrows 104b′ are manufactured from polypropylene in a single injection-molding process.

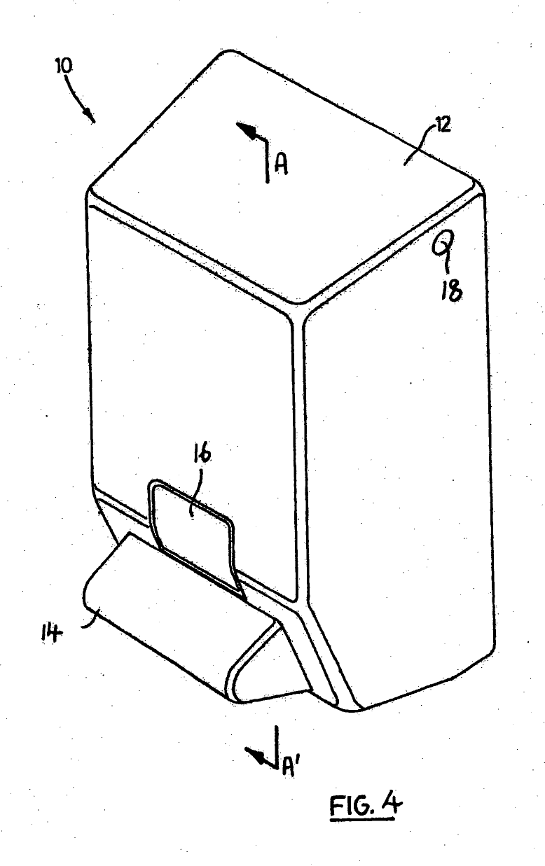

FIG. 4 shows a holder 12 that may be mounted to a wall of a washroom, for example. As is evident from FIG. 5, the holder 12 houses a liquid reservoir 20 for storing a liquid product, and an attached pump 100; the liquid reservoir 20 and connected pump 100 together form a dispenser according to the invention. These items 20, 100 will be discussed later in more detail. An actuating organ 14 is movably connected to the holder 12, and may be actuated so as to operate the pump 100. Also shown are an inspection window 16, which allows the amount of liquid product in the liquid reservoir 20 to be seen from outside. An aperture 18 allows insertion of a tool with the aid of which the holder may be unlocked and opened, allowing access to the liquid reservoir 20 and pump 100 located within.

FIG. 5 renders a cross-sectional view of the subject of FIG. 4, taken along the line A-A′. The liquid reservoir 20 is now visible, and may be embodied to be rigid or flexible (e.g., collapsible). The liquid reservoir 20 may be made of any suitable material, such as plastic or glass, and comprise a bottle, flask, or bag, for example. The liquid product contained in the liquid reservoir 20 may, for example, comprise soap, shower/bath gel, shampoo, disinfectant (including alcohols), detergent, moisturizer, hair conditioner, or mixtures of these products. The above-mentioned document U.S. Pat. No. 5,732,853 describes such a liquid reservoir, and means by which it may be coupled to a pump.

As may be seen in FIG. 5, the actuating organ 14 in this instance is hinged to the holder 12 via a hinge joint 26. This, together with the gap 28 below the actuating organ 14, means that the actuating organ 14 may be swung in and out of the holder 12. An arm 30 connects the actuating organ 14 to the pump 100 in such a manner that, when the actuating organ 14 is swung into the holder 12 about hinge point 26, arm 30 operates pump 100 so as to dispense a quantity of fluid product through the nozzle 24. Elastic biasing means, such as spring 32, ensure that the actuating organ 14 is urged back into its swung-out position when released. In general, a user depresses the actuating organ 14 using his hand palm, lower arm or elbow, for example, and collects the fluid product dispensed from the nozzle 24 in his hand or on a carrier (such as a cloth or tissue); for convenience, the nozzle 24 will therefore generally face substantially downward or outward from the holder 12.

The pump 100 is removably mounted to a bracket 36 that protrudes from the back wall 34 of the holder 12. This back wall 34 may be provided with screw-holes, magnets, or other means for mounting it to a wall or other surface. Also protruding from the back wall 34 is a lug 38B, which grips a cooperating lug 38A; however, using a tool inserted through aperture 18, these two lugs 38A, 38B may be disengaged, allowing the housing 12 to be opened, e.g., so as to replace the liquid reservoir 20 and/or pump 100 located inside.

The pump 100 may be any suitable type of pump for the application in question, such as a liquid pump, spray pump or foam pump, for example, and may operate on the basis of a movable piston, bellows and/or membrane, for example. In operation, the pump 100 may directly dispense the liquid contained within the liquid reservoir 20, or may first mix it with air to form a spray or foam, for example. In all cases, the pump 100 dispenses a fluid product from the nozzle 24.

Although the foregoing description contains many specifics, these should not be construed as limiting the scope of the present invention, but merely as providing illustrations of some of the presently preferred embodiments. Similarly, other embodiments may be devised which do not depart from the spirit or scope of the present invention. Features from different embodiments may be employed in combination. The scope of the invention is, therefore, indicated and limited only by the appended claims and their legal equivalents, rather than by the foregoing description. All additions, deletions and modifications to the invention as disclosed herein which fall within the meaning and scope of the claims are to be embraced thereby.

1. A dispenser for dispensing a fluid product, comprising:
a liquid reservoir for storing a liquid product;
a liquid inlet device for administering admission of liquid product into the liquid chamber from a liquid reservoir, the liquid inlet device comprising a body of solid material in which at least one constrictive passage is provided, the constrictive passage being constantly open and serving to allow passage of liquid product back and forth between the liquid reservoir and the liquid chamber; and
a pump that is connected to the liquid reservoir, whereby the pump comprises:
a liquid chamber for containing a dose of the liquid product;
a liquid outlet valve for regulating passage of liquid product from the liquid chamber to a dispensing head; and
compression means for applying a compressional force to liquid product in the liquid chamber, thus forcing liquid product from the liquid chamber through the liquid outlet valve and through the dispensing head.

2. A dispenser according to claim 1, wherein the liquid inlet device comprises a sheet of substantially impermeable foil in which at least one through-hole has been provided.

3. A dispenser according to claim 1, wherein the liquid inlet device comprises an elongate plug of solid material having an outer surface in which a plurality of longitudinal furrows has been provided.

4. A dispenser according to claim 1, wherein the constrictive passage of the liquid inlet device demonstrates a tapered form when observed along a direction extending from the liquid reservoir toward the liquid chamber.

5. A dispenser according to claim 4, wherein the liquid inlet device comprises a sheet of substantially impermeable foil in which at least one through-hole has been provided.

6. A dispenser according to claim 4, wherein the liquid inlet device comprises an elongate plug of solid material having an outer surface in which a plurality of longitudinal furrows has been provided.

7. A dispenser according to claim 1, wherein the liquid inlet device comprises a body of fibrous material.

8. A dispenser according to claim 1, wherein the liquid inlet device comprises a body of granulate material.

9. A dispenser according to claim 1, wherein the liquid product is selected from the group comprised of soap, shampoo, disinfectant, detergent, moisturizer, hair conditioner, and mixtures of these products.

10. A pump for dispensing a fluid product, comprising:
a liquid chamber for containing a dose of liquid product;
a liquid inlet device for administering admission of liquid product into the liquid chamber from a liquid reservoir, the liquid inlet device comprising a body of solid material in which at least one constrictive passage is provided, the constrictive passage being constantly open and serving to allow passage of liquid product back and forth between the liquid reservoir and the liquid chamber;
a liquid outlet valve for regulating passage of liquid product from the liquid chamber to a dispensing head; and
compression means for applying a compressional force to liquid product in the liquid chamber, thus forcing liquid product from the liquid chamber through the liquid outlet valve and through the dispensing head.

11. A dispenser according to claim 10, wherein the liquid inlet device comprises a sheet of substantially impermeable foil in which at least one through-hole has been provided.

12. A dispenser according to claim 10, wherein the liquid inlet device comprises an elongate plug of solid material having an outer surface in which a plurality of longitudinal furrows has been provided.

13. A dispenser according to claim 10, wherein the constrictive passage of the liquid inlet device demonstrates a tapered form when observed along a direction extending from the liquid reservoir toward the liquid chamber.

14. A dispenser according to claim 10, wherein the liquid inlet device comprises a body of fibrous material.

15. A dispenser according to claim 10, wherein the liquid inlet device comprises a body of granulate material.

16. A dispenser according to claim 10, wherein the liquid product is selected from the group comprised of soap, shampoo, disinfectant, detergent, moisturizer, hair conditioner, and mixtures of these products.

17. A holder comprising a housing for removably accommodating at least part of a dispenser for dispensing a fluid product, the dispenser comprising:
a liquid reservoir for storing a liquid product;
a liquid inlet device for administering admission of liquid product into the liquid chamber from a liquid reservoir, the liquid inlet device comprising a body of solid material in which at least one constrictive passage is provided, the constrictive passage being constantly open and serving to allow passage of liquid product back and forth between the liquid reservoir and the liquid chamber; and
a pump that is connected to the liquid reservoir, the holder further comprising at least one of:
an actuating organ movably connected to the housing and serving to cooperate with the pump, whereby the pump may be actuated by manually moving the actuating organ;
a detector for detecting that a member onto which fluid is to be dispensed has been offered to a dispensing head of the pump; and
an electric actuator for actuating the pump on the basis of a signal output from the detector.

18. A holder according to claim 17, comprising means for mounting the housing to a surface.
